(19) United States
(12) Patent Application Publication
(10) Pub. No.: US 2025/0187525 A1
(43) Pub. Date: Jun. 12, 2025

(54) MODULAR CAMPER SHELL WITH INTERCHANGEABLE ROOFS

(71) Applicant: Jastopher LLC, Sacramento, CA (US)

(72) Inventor: Christopher Grajo, Sacramento, CA (US)

(21) Appl. No.: 18/977,847

(22) Filed: Dec. 11, 2024

Related U.S. Application Data
(60) Provisional application No. 63/608,772, filed on Dec. 11, 2023.

(51) Int. Cl. B60P 3/38

(52) U.S. Cl. CPC B60P 3/38

(57) ABSTRACT

Methods, devices, and systems are described for a modular camper enclosure with interchangeable roofs. The modular camper shell is configured to selectively couple to a vehicle. The modular camper shell has four walls in which each wall of the four walls is configured to connect at least two walls of the four walls. The at least two walls of the four walls have a first upward-facing edge and a second upward-facing edge extending approximately parallel to each other. The first upward-facing edge and the second upward-facing edge have a plurality of apertures through which a plurality of bolts may be inserted. A rooftop panel is configured to couple to the at least the first upward-facing edge and the second upward-facing edge using the plurality of bolts. The rooftop panel has a plurality of openings configured to align with the plurality of apertures.

### CROSS-REFERENCE TO RELATED APPLICATIONS

This application claims priority to and the benefit of the earlier filing date of U.S. Provisional Patent Application Ser. No. 63/608,772, filed Dec. 11, 2023, the contents of which are fully incorporated by reference herein in its entirety.

### TECHNICAL FIELD

The present disclosure relates generally to vehicle enclosures, and more particularly, to modular camper shells with interchangeable rooftop paneling.

### BACKGROUND

Pickup trucks, trailers, and utility vehicles can have modular camper shells. Modular camper shells protect vehicle cargo from the elements. While conventional modular camper shells may be used for shelter, they primarily are used for utility and storage purposes. Pop-up campers are better suited for providing shelter and provide additional space and shelter for passengers. Pop-up campers are also mounted to pickup trucks, trailers, and utility vehicles. Both pop-up campers and modular camper shells have their distinct purposes and attributes. However, switching between pop-up campers and modular camper shells is difficult, given their large weight and size.

Modular camper shells and pop-up campers are difficult to remove. Typically, special tools, devices, systems, or multiple people are necessary to remove and handle modular camper shells and pop-up campers. Once the pop-up camper or modular camper shell is removed, storage of the pop-up camper or modular camper shell requires considerable space. The large sizes of pop-up campers or modular camper shells make them difficult to store. Thus, while the current pop-up campers and modular camper shells have their unique advantages, switching between pop-up campers and modular camper shells requires a difficult removal process and a large amount of space for storage.

### SUMMARY

In an aspect, a system may comprise a modular camper shell configured to selectively couple to a vehicle. The modular camper shell has four walls in which each wall of the four walls is configured to connect at least two walls of the four walls. The at least two walls of the four walls have a first upward-facing edge and a second upward-facing edge extending approximately parallel to each other, the first upward-facing edge and the second upward-facing edge having a plurality of apertures through which a plurality of bolts may be inserted. The system may further comprise a rooftop panel configured to couple to the at least the first upward-facing edge and the second upward-facing edge using the plurality of bolts. The rooftop panel has a plurality of openings configured to align with the plurality of apertures. The rooftop panel is configured to be removed from the first upward-facing edge and the second upward-facing edge in response to removing the plurality of bolts at the plurality of openings and the plurality of apertures.

One or more of the following features can be included in any feasible combination. For example, a rooftop tent configured to couple to the at least the first upward-facing edge and the second upward-facing edge using the plurality of bolts, the rooftop tent having a second plurality of openings configured to align with the plurality of apertures. In some variations, the rooftop tent is configured to be removed from the first upward-facing edge and the second upward-facing edge in response to removing the plurality of bolts at the plurality of openings and the plurality of apertures. Additionally, the rooftop tent has a first layer and a second layer that are coupled by a hinge at ends of the first layer and the second layer, the first layer configured to rotate away from the second layer using the hinge to an open position, and wherein the first layer is configured to rotate towards the second layer using the hinge to a closed position.

In some variations, the first layer is an upper layer and the second layer is a lower layer and an upper portion may be angled relative to the lower layer in response to the rooftop tent being in the open position. Additionally, at least one of the first layer or the second layer has a slot configured to receive a gas strut for supporting the first layer over the second layer while in the open position. Further, the modular camper shell includes side panels configured to open and close using a hinge, and wherein the modular camper shell includes a back panel configured to be locked.

In some variations, the side panels are configured to be supported by a gas strut in response to being in an open position. Additionally, the modular camper shell includes a vertical mounting point configured to couple to side railings of the vehicle to prevent vertical movement of the modular camper shell. Further, the vertical mounting point extends down from a bottom edge of the modular camper shell in a vertical direction. Additionally, the modular camper shell includes a horizontal mounting point configured to couple to side railings of the vehicle to prevent horizontal movement of the modular camper shell.

In another aspect, a system may comprise a modular camper shell configured to selectively couple to a vehicle, the modular camper shell having four walls in which each wall of the four walls is configured to connect at least two walls of the four walls, the at least two walls of the four walls having a first upward-facing edge and a second upward-facing edge extending approximately parallel to each other, the first upward-facing edge and the second upward-facing edge having a plurality of apertures through which a plurality of bolts may be inserted. The system may also comprise a rooftop tent configured to couple to the at least the first upward-facing edge and the second upward-facing edge using the plurality of bolts, the rooftop tent having a plurality of openings configured to align with the plurality of apertures. The rooftop tent may be configured to be removed from the first upward-facing edge and the second upward-facing edge in response to removing the plurality of bolts at the plurality of openings and the plurality of apertures.

One or more of the following features can be included in any feasible combination. For example, the rooftop tent has a first layer and a second layer that are coupled by a hinge at ends of the first layer and the second layer, the first layer configured to rotate away from the second layer using the hinge to an open position, and wherein the first layer is configured to rotate towards the second layer using the hinge to a closed position. Further, the first layer is an upper layer and the second layer is a lower layer and an upper portion may be angled relative to the lower layer in response to the rooftop tent being in the open position. Additionally, at least one of the first layer or the second layer has a slot configured to receive a gas strut for supporting the first layer over the second layer while in the open position.

In some variations, the system may include a rooftop panel configured to couple to the at least the first upward-facing edge and the second upward-facing edge using the plurality of bolts, the rooftop panel having a second plurality of openings configured to align with the plurality of apertures. The rooftop panel is configured to be removed from the first upward-facing edge and the second upward-facing edge in response to removing the plurality of bolts at the plurality of openings and the plurality of apertures.

In some variations, the modular camper shell includes side panels configured to open and close using a hinge, and wherein the modular camper shell includes a back panel configured to be locked. Further, the side panels are configured to be supported by a gas strut in response to being in an open position. Additionally, the modular camper shell includes a vertical mounting point configured to couple to side railings of the vehicle to prevent vertical movement of the modular camper shell.

In some variations, the vertical mounting point extends down from a bottom edge of the modular camper shell in a vertical direction. Further, the modular camper shell includes a horizontal mounting point configured to couple to side railings of the vehicle to prevent horizontal movement of the modular camper shell.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 depicts an example of a front view of a modular camper shell with a rooftop panel, the modular camper shell being configured to be mounted on a pickup truck or utility trailer;

FIG. 2 depicts an example of the modular camper shell with the rooftop panel removed and one or more side panels in the open position;

FIG. 3 depicts an example of a rooftop tent that is configured to be mounted to the upward-facing edges of the modular camper shell;

FIG. 4 depicts an example of a side view of the modular camper shell having a plurality of vertical mounting points to which the modular camper shell is configured to couple to the vehicle;

FIG. 5 depicts an example of a side view of the rooftop tent in the closed position coupled to the modular camper shell at the upward-facing edges of the modular camper shell;

FIG. 6 depicts an example of a side view of the rooftop tent in an open position coupled to the modular camper shell at the upward-facing edges of the modular camper shell, the rooftop tent exposing modular bed paneling at the first layer of the rooftop tent;

FIG. 7 depicts an example of a bottom view of an interior of the modular camper shell configured to be mounted on a pickup truck or utility trailer, the modular camper shell coupled to the rooftop tent at the upward-facing edges of the modular camper shell;

FIG. 8 depicts an example of a bottom view of an interior of the modular camper shell, the modular camper shell being coupled to the rooftop tent in the open position;

FIG. 9 depicts an example of a side view of the modular camper shell attached to the rooftop panel, the modular camper shell having side panels coupled to a hinge for opening and closing the side panels;

FIG. 10 depicts an example of a back view of the back panel of the modular camper shell with an integrated power lock system in the closed position;

FIG. 11 depicts an example of a back view of the back panel of the modular camper shell with an integrated power lock system in the open and unlocked position, the modular camper shell being attached to the rooftop panel;

FIG. 12 depicts an example of a back view of the back panel of the modular camper shell with an integrated power lock system in the closed and locked position, the modular camper shell being attached to the rooftop panel;

FIG. 13 depicts an example of a back view of the back panel of the modular camper shell with an integrated power lock system in the closed position with the rooftop tent in the open position being mounted on the modular camper shell;

FIG. 14 depicts an example of a bottom view of an interior of the modular camper shell configured to be mounted on a pickup truck or utility trailer with the side panels and the back panel in the open position;

FIG. 15 depicts an example of a bottom view of an interior of the modular camper shell coupled to the rooftop panel;

FIG. 16 depicts an example of a bottom view of an interior of the modular camper shell coupled to the rooftop panel using a plurality of bolts inserted into the plurality of apertures;

FIG. 17 depicts another example of a bottom view of an interior of the modular camper shell coupled to the rooftop panel using a plurality of bolts inserted into the plurality of apertures;

FIG. 18 depicts an example of the rooftop tent in the closed position that is configured to be mounted to the upward-facing edges of the modular camper shell using a plurality of bolts configured to be inserted into the plurality of apertures; and

FIG. 19 depicts an example of the rooftop tent in the open position that is configured to be mounted to the upward-facing edges of the modular camper shell using a plurality of bolts configured to be inserted into the plurality of apertures.

### DETAILED DESCRIPTION

The methods, systems, and apparatuses described herein are for a modular camper shell with a rooftop panel top panel. In the following detailed description, reference is made to the accompanying drawings, which form a part hereof. In the drawings, similar symbols generally identify similar components, unless context dictates otherwise. The illustrative alternatives described in the detailed description, drawings, and claims are not meant to be limiting. Other alternatives may be used and other changes may be made without departing from the spirit or scope of the subject matter presented here. It will be readily understood that the aspects, as generally described herein, and illustrated in the Figures, can be arranged, substituted, combined, and designed in a wide variety of different configurations, all of which are explicitly contemplated and make part of this application.

The modular camper shell described herein enables a smooth transition from a rooftop panel to a rooftop tent. The modular camper shell with the rooftop panel may provide a flat, aerodynamic profile that is advantageous for traveling and storing cargo. The modular camper shell with the rooftop panel may provide privacy by covering the cargo inside the modular camper shell. The modular camper shell may provide an aerodynamic profile for the vehicle and may be aligned with the frame of the vehicle. If additional space is needed for shelter, the rooftop panel may be removed and replaced with a rooftop tent. The rooftop tent may selectively expand and contract to provide additional space.

The modular camper shell may be configured to selectively couple to the rooftop panel and the rooftop tent. To attach the rooftop tent, the rooftop panel may be removed from the modular camper shell and the rooftop tent may be coupled to the modular camper shell. To attach the rooftop panel, the rooftop tent may be removed from the modular camper shell and the rooftop panel may be coupled to the modular camper shell. The modular camper shell may include a plurality of apertures for coupling the rooftop panel and the rooftop tent to the modular camper shell. The rooftop panel and the rooftop tent may also include a plurality of apertures that are configured to align with the plurality of apertures at the modular camper shell.

The modular camper shell may be configured to attach to the rooftop panel. The rooftop panel may include a hatch through which passengers or cargo may pass through. The rooftop panel may include a plurality of L-tracks running along the length of the rooftop panel at the edges. The plurality of L-tracks may include grooves for attaching to cargo above the rooftop panel.

The modular camper shell may be configured to attach to the rooftop tent. The rooftop tent may include two portions that are connected by a hinge at one end. The two portions may be aligned or may be separated. When the two portions are separated, the rooftop tent may be positioned in an open state. When the two portions are aligned, the rooftop tent may be positioned in a closed state. In some embodiments, the two portions include an upper portion and a lower portion. The upper portion may rotate away from the lower portion to create an interior portion of the rooftop tent when the upper portion is angled relative to the lower portion. A gas strut may be used to sustain the upper portion above the lower portion. Fabric may extend between the upper portion and the lower portion to create privacy for the pop-up tent. Additionally, and/or alternatively, a lining may extend between the upper portion and the lower portion to allow transparency and free flow of air. In some embodiments, modular bed paneling may be aligned along the bottom of the tent. The modular bed paneling may be removable to allow cargo and/or passengers to pass between the interior of the modular camper shell and the interior of the rooftop tent.

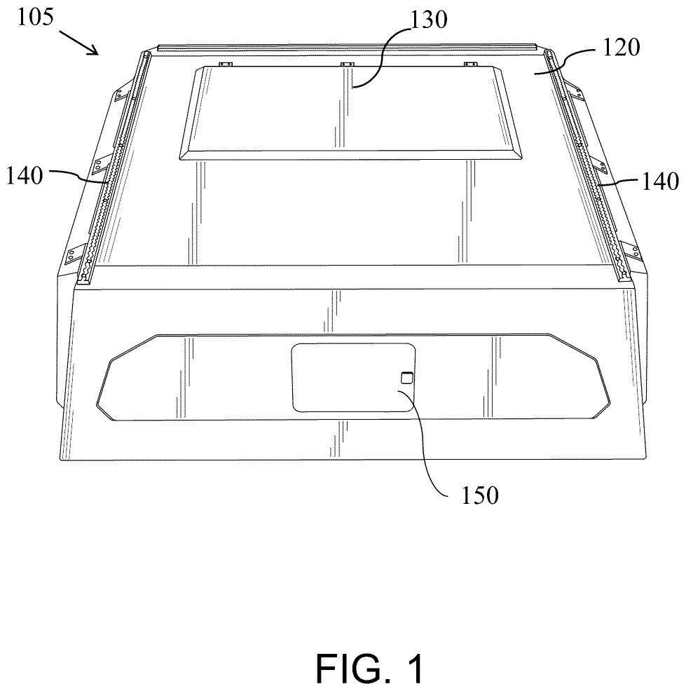

FIG. 1 depicts an example of a front view of a modular camper shell 105 with a rooftop panel 120, the modular camper shell 105 being configured to be mounted on a pickup truck or utility trailer. The modular camper shell 105 may include the rooftop panel 120. The modular camper shell 105 may include a front portion with a sliding middle front window 150. The modular camper shell 105 may include two side portions with side panels. The modular camper shell 105 may include a back portion with a back panel 240 configured to open and close. The modular camper shell 105 may taper from the bottom end to the top end. The rooftop panel 120 may be configured to cover the upward-facing edges 210 of the front portion, the upward-facing edges 210 of the two side portions, and upward-facing edges 210 of the back portion of the modular camper shell 105. The rooftop panel 120 may be removed from the modular camper shell 105 and exchanged with the rooftop tent 310.

The rooftop panel 120 includes an escape hatch 130 configured to open about a hinge. The hatch 130 may include a gas strut to support the hatch 130 while in the open position. The rooftop panel 120 may also include a sliding middle front window 150 to allow for the egress/ingress of cargo between the vehicle cabin and the interior of the modular camper shell 105. The rooftop panel 120 may also include an L-track 140 mounted along the top side of the rooftop panel 120 for storing cargo. The L-track 140 may be mounted along either side of the rooftop panel 120 or both sides of the rooftop panel 120. The L-track 140 may extend along the length of the vehicle above the wheels. In some embodiments, the L-tracks 140 may include grooves configured to receive cargo or fastening materials for cargo. In some embodiments, the rooftop tent 310 may attach to the grooves of the L-track 140.

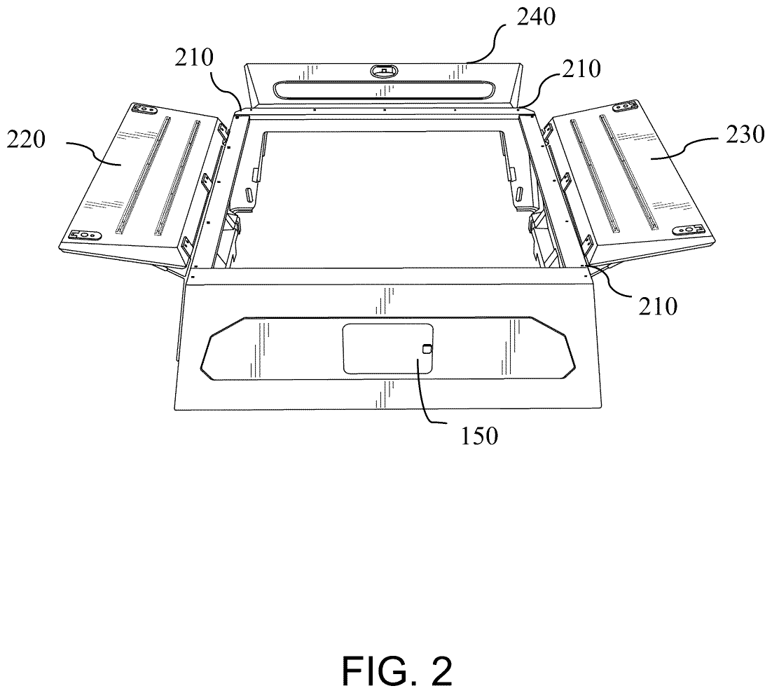

FIG. 2 depicts an example of the modular camper shell 105 with the rooftop panel 120 removed and one or more side panels in the open position. The rooftop panel 120 may include side panels through which cargo may be passed through to the interior portion of the modular camper shell 105. The one or more side panels may be coupled to a hinge for opening and closing the side panels. The modular camper shell 105 may have the rooftop panel 120 removed to expose the interior portion of the modular camper shell 105. A plurality of apertures may be situated along the upward-facing edges 210 of the side portions of the modular camper shell 105 for securing the rooftop panel 120 to the modular camper shell 105. In some embodiments, the plurality of apertures may be included along the upward-facing edge of the back portion of the modular camper shell 105 and along the upward-facing edge of the front portion of the modular camper shell 105.

The modular camper shell 105 may include side panels at the side portions. The side panels may include a driver-side gullwing 230 and a passenger-side gullwing 220. The driver-side gullwing 230 may include one or more L-tracks 140 to which cargo may be attached. The driver-side gullwing 230 may be configured to open and close using a hinge. For example, the driver-side gullwing 230 may rotate about a hinge to extend away from the modular camper shell 105. The driver-side gullwing 230 may be configured to securely lock to the modular camper shell 105. For example, the driver-side gullwing 230 may include a plurality of compression latches for securing the passenger-side gullwing 220 to the modular camper shell 105. The passenger-side gullwing 220 may include one or more L-tracks 140 to which cargo may be attached. The passenger-side gullwing 220 may be configured to open and close using a hinge. For example, the passenger-side gullwing 220 may rotate about a hinge to extend away from the modular camper shell 105. The passenger-side gullwing 220 may be configured to securely lock to the modular camper shell 105. For example, the passenger-side gullwing 220 may include a plurality of compression latches for securing the passenger-side gullwing 220 to the modular camper shell 105.

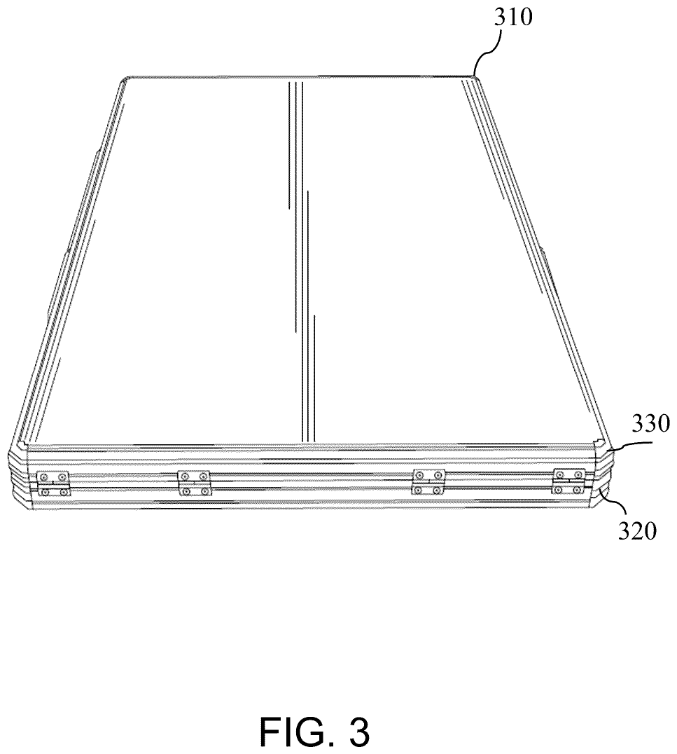

FIG. 3 depicts an example of a rooftop tent 310 that is configured to be mounted to the upward-facing edges 210 of the modular camper shell 105. The rooftop tent 310 may be configured to selectively attach and detach from the modular camper shell 105. Unlike other pop-up tents, the rooftop tent 310 has a plurality of apertures along the bottom portion of the rooftop tent 310 to selectively attach and detach from the modular camper shell 105.

The rooftop tent 310 may include two layers that are connected by a hinge at one end. The two portions may be aligned or may be separated. When the two layers are separated, the rooftop tent 310 may be positioned in an open state. When the two layers are aligned, the rooftop tent 310 may be positioned in a closed state. In some embodiments, the two layers include an upper layer 330 and a lower layer 320. The upper layer 330 may rotate away from the lower layer 320 to create an interior portion of the rooftop tent 310 when the upper layer 330 is angled relative to the lower layer 320. A gas strut may be used to sustain the upper layer 330 above the lower layer 320. Fabric may extend between the upper layer 330 and the lower layer 320 to create privacy for the pop-up tent. Additionally, and/or alternatively, a lining may extend between the upper layer 330 and the lower layer 320 to allow transparency and free flow of air. In some embodiments, modular bed paneling 610 may be aligned along the bottom of the rooftop tent 310. The modular bed paneling 610 may be removable to allow cargo and/or passengers to pass between the interior of the modular camper shell 105 and the interior of the rooftop tent 310.

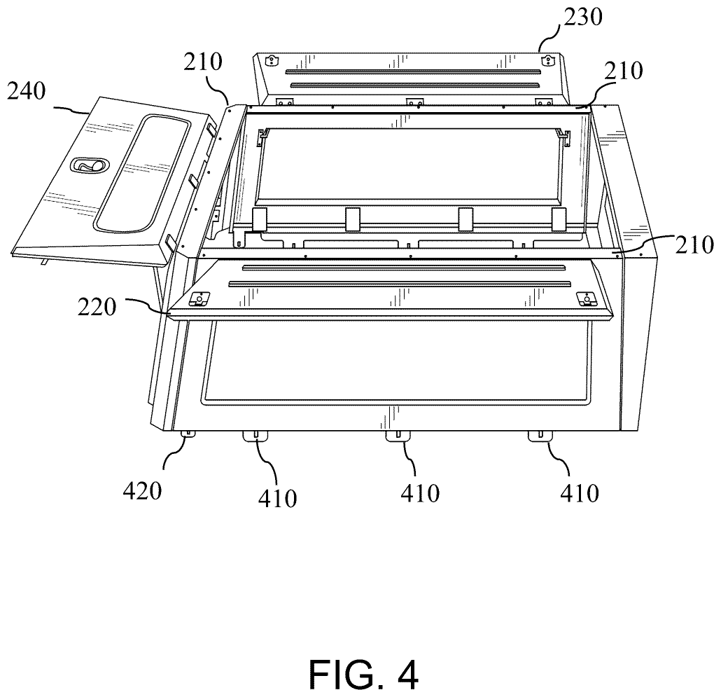

FIG. 4 depicts an example of a side view of the modular camper shell 105 having a plurality of vertical mounting points 410 to which the modular camper shell 105 is configured to couple to the vehicle. The vertical mounting points 410 may be situated along a bottom edge of the modular camper shell 105. The vertical mounting points 410 may be situated at the bottom edges of the side portions of the modular camper shell 105. In some embodiments, the vertical mounting points 410 may be situated at the bottom edges of the front portions or the back panel 240 of the modular camper shell 105. In some embodiments, the vertical mounting points 410 may attach to the rails of the pickup truck, the trailer, or the utility vehicle. Attaching the vertical mounting points 410 to the rails of the vehicle securely fastens the modular camper shell 105 to the vehicle to prevent vertical movement.

The vertical mounting points 410 may extend from the bottom edge of the modular camper shell 105 in a vertical direction. The vertical mounting points 410 may be spaced apart from each other along the bottom edge of the modular camper shell 105. The vertical mounting points 410 may be configured to couple to the side railings of the pickup truck, the trailer, or the utility vehicle. The vertical mounting points 410 may be configured to couple to the side portions of the pickup truck, the trailer, or the utility vehicle. The vertical mounting points 410 may be configured to couple above the wheel wells of the pickup truck, the trailer, or the utility vehicle. Both sides of the vehicle may include one or more vertical mounting points 410.

In some embodiments, the bottom edge of the modular camper shell 105 may include horizontal mounting points 420. The horizontal mounting points 420 may be situated along a bottom edge of the modular camper shell 105. The horizontal mounting may be situated at the bottom edges of the side portions of the modular camper shell 105. The horizontal mounting points 420 may extend from the bottom edge of the modular camper shell 105 in a horizontal direction. The horizontal mounting points 420 may be spaced apart from each other along the bottom edge of the modular camper shell 105. Attaching the horizontal mounting points 420 to the sides of the vehicle securely fastens the modular camper shell 105 to the vehicle using bolts to prevent horizontal movement of the modular camper shell 105. Both sides of the vehicle may include one or more horizontal mounting points 420.

A plurality of apertures may be situated along the upward-facing edges 210 of the side portions of the modular camper shell 105 for securing the rooftop panel 120 to the modular camper shell 105. In some embodiments, the plurality of apertures may be included along the upward-facing edge of the back panel 240 of the modular camper shell 105 and along the upward-facing edge of the front portion of the modular camper shell 105.

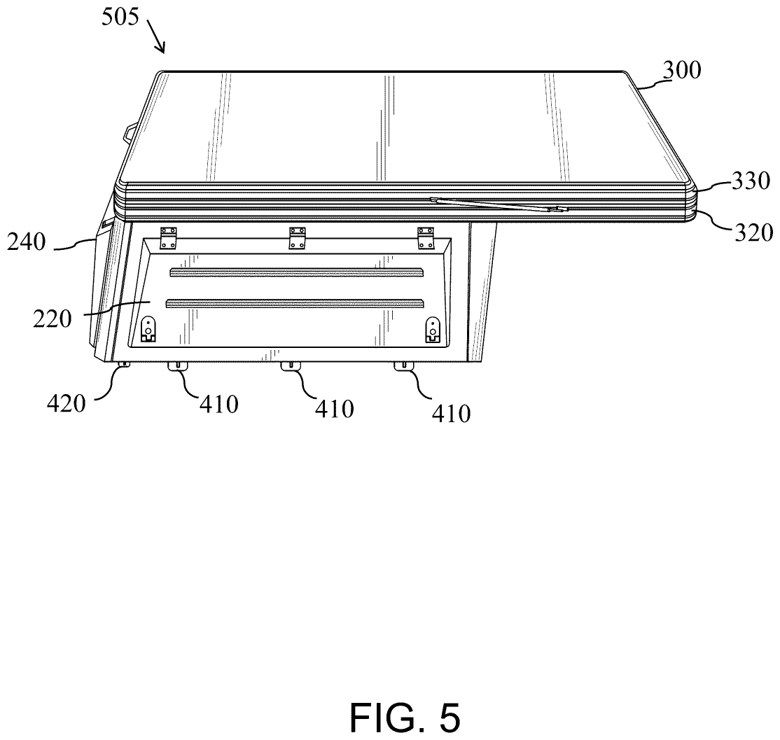

FIG. 5 depicts an example of a side view of the rooftop tent 310 in the closed position coupled to the modular camper shell 105 at the upward-facing edges 210 of the modular camper shell 105. The rooftop tent 310 may have the lower layer 320 and the upper layer 330 aligned in the closed position.

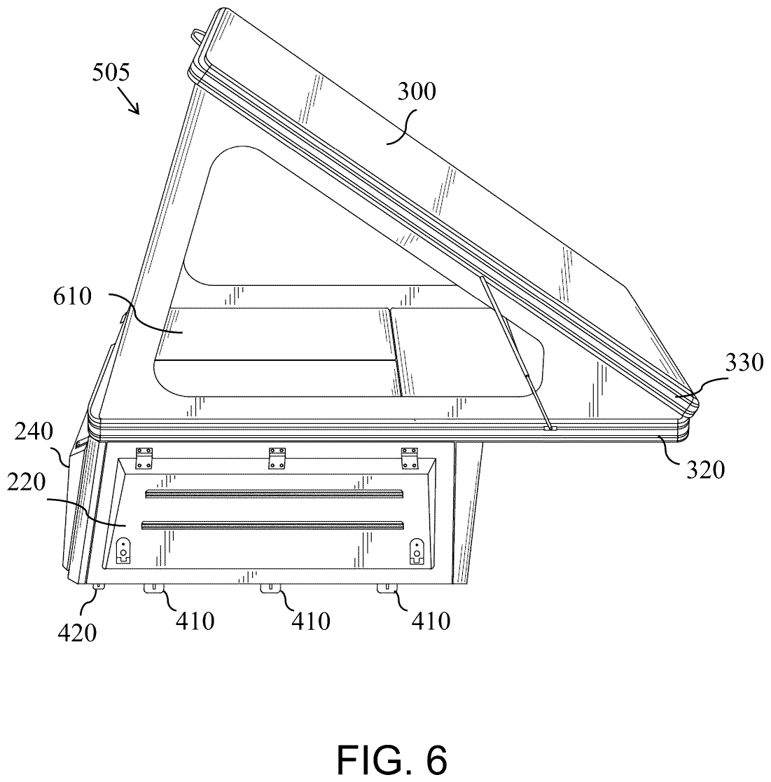

FIG. 6 depicts an example of a side view of the rooftop tent 310 in an open position coupled to the modular camper shell 105 at the upward-facing edges 210 of the modular camper shell 105, the rooftop tent 310 exposing modular bed paneling 610 at the first layer of the rooftop tent 310. The modular bed paneling 610 may be removable to allow cargo and/or passengers to pass between the interior of the modular camper shell 105 and the interior of the rooftop tent 310. In some embodiments, the modular bed paneling 610 may be modular aluminum platforms to allow users to enter and exit from the bottom of the tent and to the bed of the pickup truck.

The modular bed paneling 610 may form the floor of the rooftop tent 310. The modular bed paneling 610 may be supported by a lip that goes around the perimeter of the top portion of the modular camper shell 105. The modular bed paneling 610 may be selectively removed to allow passage between the rooftop tent 310 and the interior of the modular camper shell 105. In some embodiments, the modular bed paneling 610 may be supported by a lip that goes around the perimeter of the lower layer 320 of the rooftop tent 310. The modular bed paneling 610 may be selectively removed and stored to increase the space inside of the rooftop tent 310. The modular bed paneling 610 may also be used to form privacy walls or structural reinforcement for the rooftop tent 310. The rooftop tent 310 may be built with modular aluminum platforms, which allow the user to enter and exit from the bottom of the tent and to the bed of the pickup truck.

The rooftop tent 310 may be configured to couple to the at least the first upward-facing edge and the second upward-facing edge of the modular camper shell 105 using the plurality of bolts. The rooftop tent 310 may have a plurality of openings configured to align with the plurality of apertures. The rooftop tent 310 may be configured to be removed from the first upward-facing edge and the second upward-facing edge in response to removing the plurality of bolts at the plurality of openings and the plurality of apertures.

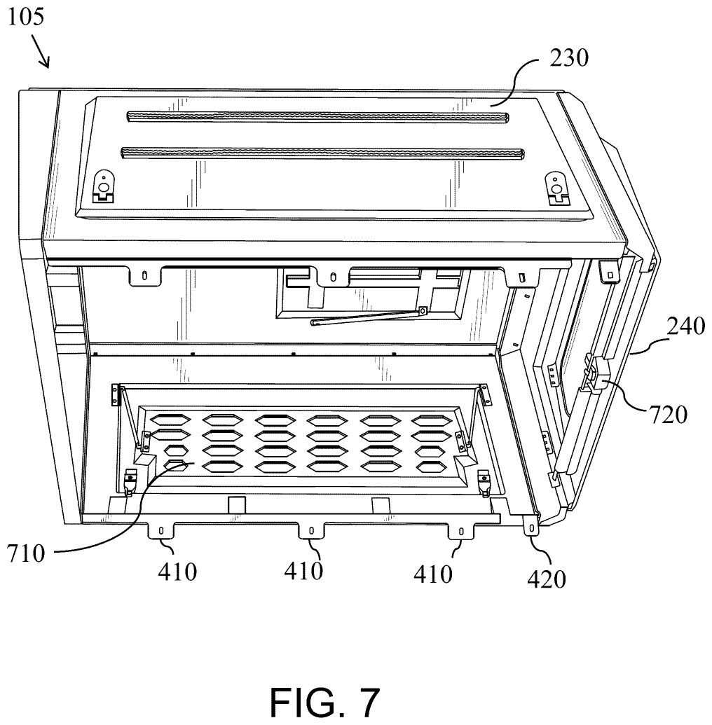

FIG. 7 depicts an example of a bottom view of an interior of the modular camper shell 105 configured to be mounted on a pickup truck or utility trailer, the modular camper shell 105 coupled to the rooftop tent 310 at the upward-facing edges 210 of the modular camper shell 105. The modular camper shell 105 may include side panels with a backside that includes Molle panels 710. The Molle panels 710 may be perforated or have polygon cutouts throughout the panel. The side panels may include gas struts to adjust the side panels between an open position and a closed position. Both of the side panels may include the Molle panels 710 at the backside of the side panels. Both of the side panels may include gas struts to adjust the side panels between an open position and a closed position.

The back panel 240 of the modular camper shell 105 may include an integrated power lock system 720. The integrated power lock system 720 may lock and unlock the back panel 240 to allow access to the interior of the modular camper shell 105. The integrated power lock system 720 may be locked or unlocked in the closed position. The integrated power lock system 720 may be in the open position when unlocked. The integrated power lock system 720 may be unlocked or locked using a remote or a key entry.

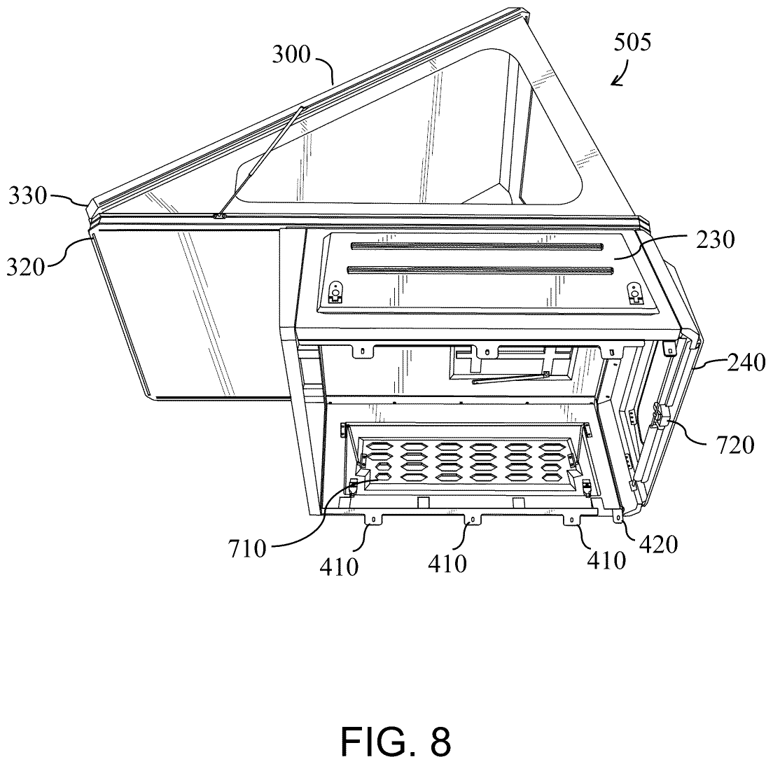

FIG. 8 depicts an example of a bottom view of an interior of the modular camper shell 105, the modular camper shell 105 being coupled to the rooftop tent 310 in the open position. The rooftop tent 310 may include slots to which the gas struts may attach. The slots may extend down the length of the lower layer 320 and/or the upper layer 330. In some embodiments, there are multiple slots that extend down the length of the lower layer 320 and/or the upper layer 330. The gas strut may be coupled to the interior portion of the slot and one or more of the ends of the gas strut may travel along the slots in response to opening the rooftop tent 310 or closing the rooftop tent 310. The one or more ends of the gas strut may travel along the slots in response to lifting the upper layer 330 of the rooftop tent 310 or lowering the upper layer 330 of the rooftop tent 310. In some embodiments, the rooftop tent 310 may include a plurality of L-tracks 140 for storing cargo. The plurality of L-tracks 140 may include grooves through for attaching to cargo above the rooftop tent 310.

The rooftop tent 310 may include a lining between the upper portion and the lower portion. In some embodiments, the modular camper shell 105 may include a plurality of apertures for coupling the rooftop panel 120 and the rooftop tent 310 to the modular camper shell 105.

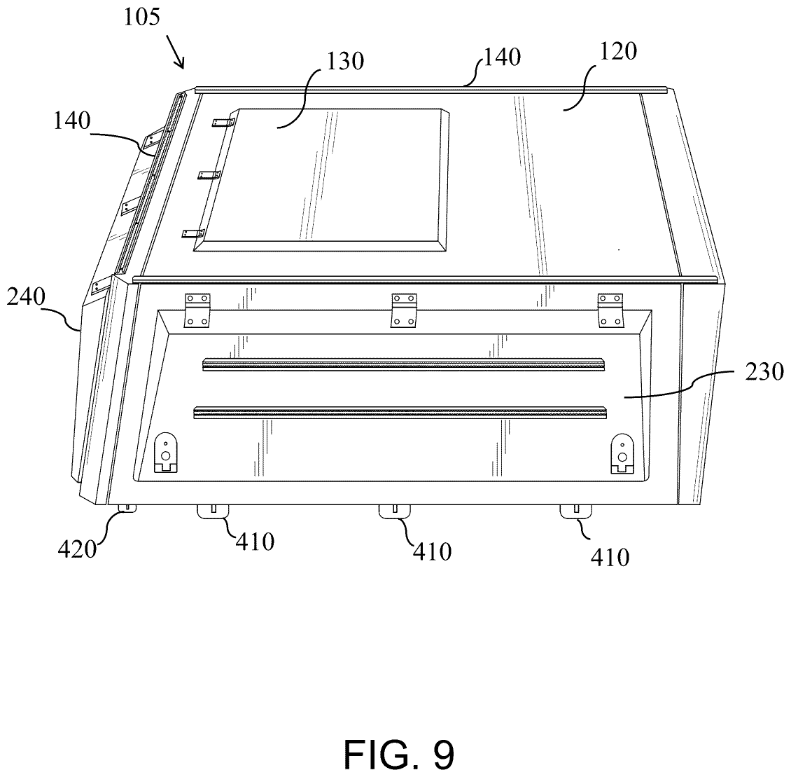

FIG. 9 depicts an example of a side view the modular camper shell 105 attached to the rooftop panel 120, the modular camper shell 105 having side panels coupled to a hinge for opening and closing the side panels. The modular camper shell 105 may be configured to selectively couple to a vehicle. The modular camper shell 105 may have four walls in which each wall of the four walls is configured to connect at least two walls of the four walls. The at least two walls of the four walls have a first upward-facing edge and a second upward-facing edge extending approximately parallel to each other. The first upward-facing edge and the second upward-facing edge may have a plurality of apertures through which a plurality of bolts may be inserted. A rooftop panel 120 may be configured to couple to the at least the first upward-facing edge and the second upward-facing edge using the plurality of bolts. The rooftop panel 120 may have a plurality of openings configured to align with the plurality of apertures.

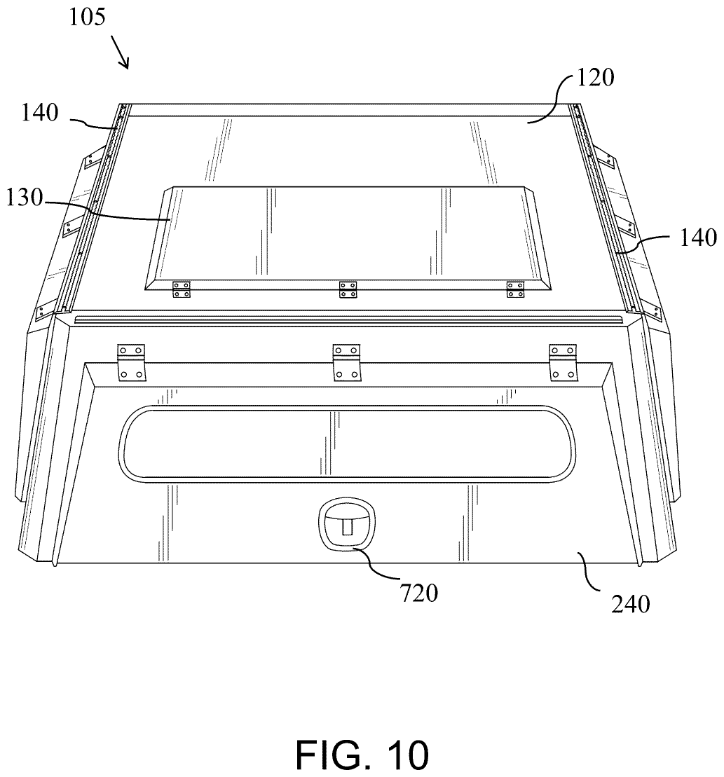

FIG. 10 depicts an example of a back view of the back panel 240 of the modular camper shell 105 with an integrated power lock system 720 in the closed position.

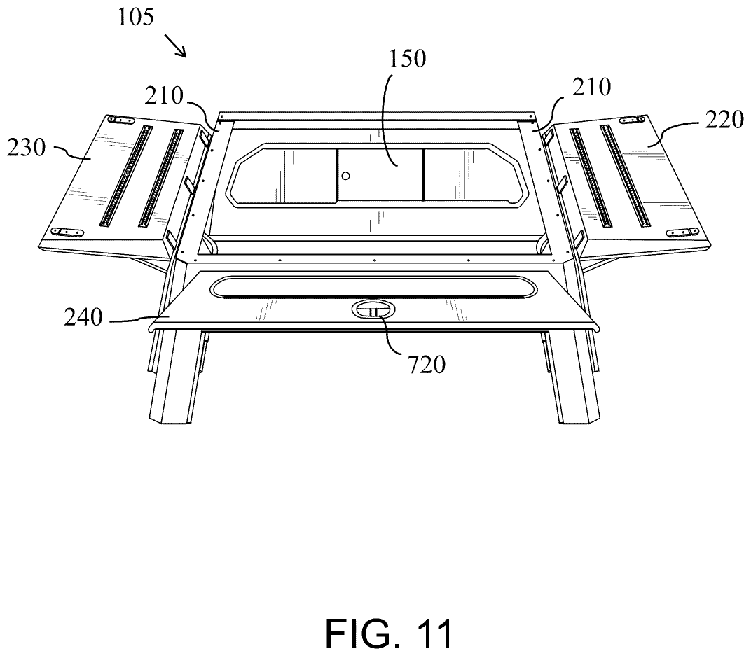

FIG. 11 depicts an example of a back view of the back panel 240 of the modular camper shell 105 with an integrated power lock system 720 in the open and unlocked position, the modular camper shell 105 being attached to the rooftop panel 120.

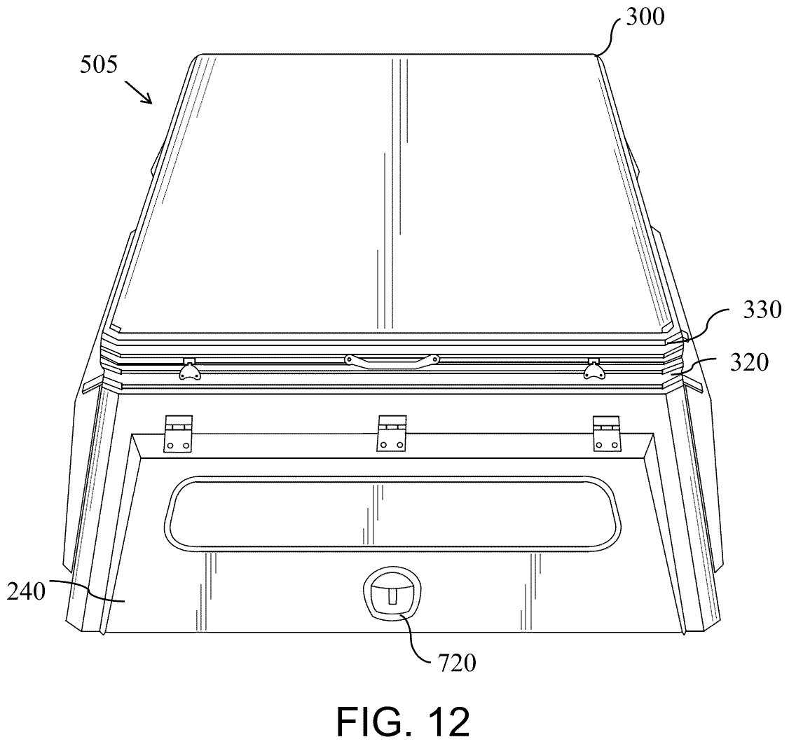

FIG. 12 depicts an example of a back view of the back panel 240 of the modular camper shell 105 with an integrated power lock system 720 in the closed and locked position, the modular camper shell 105 being attached to the rooftop panel 120.

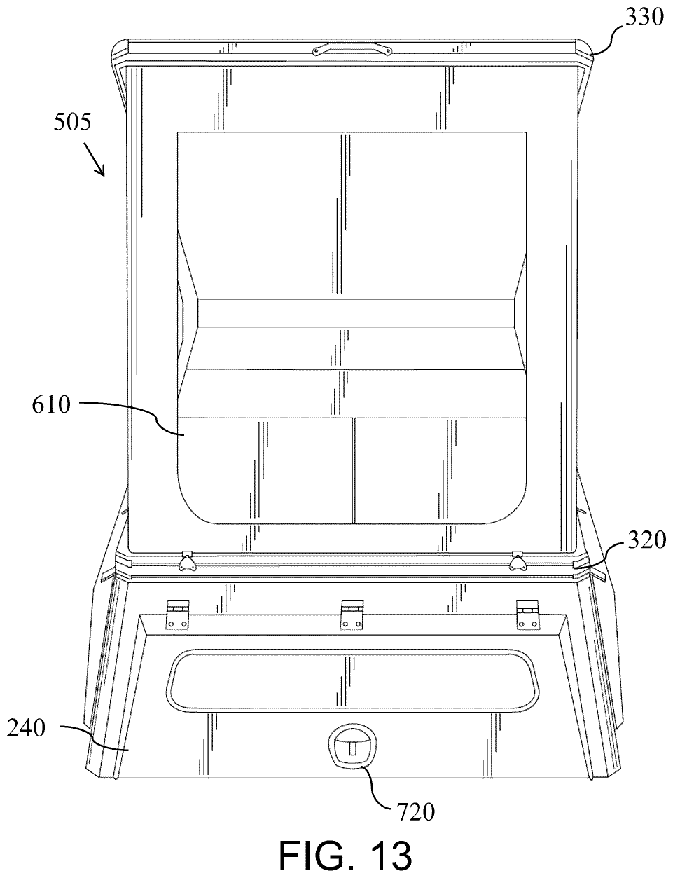

FIG. 13 depicts an example of a back view of the back panel 240 of the modular camper shell 105 with an integrated power lock system 720 in the closed position with the rooftop tent 310 in the open position being mounted on the modular camper shell 105.

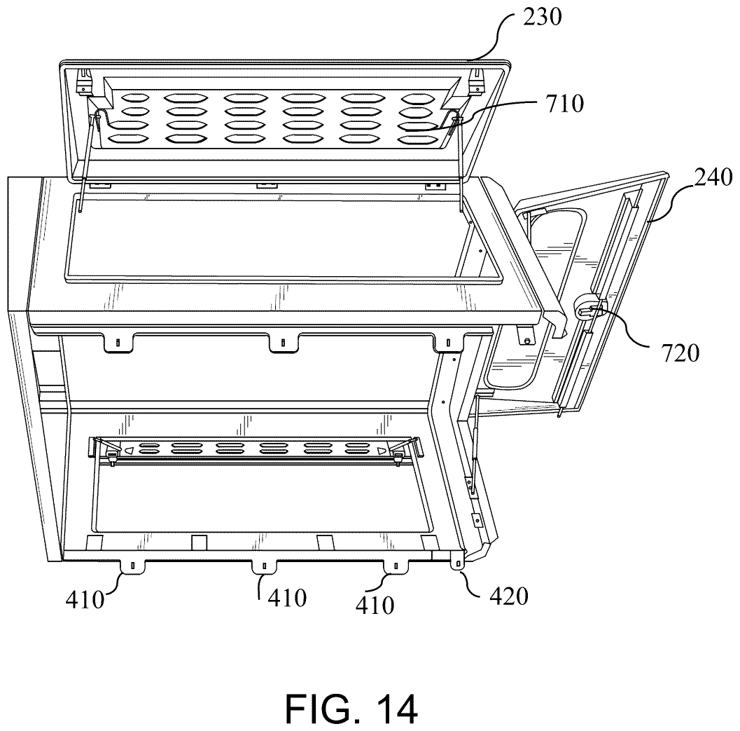

FIG. 14 depicts an example of a bottom view of an interior of the modular camper shell 105 configured to be mounted on a pickup truck or utility trailer with the side panels and the back panel 240 in the open position.

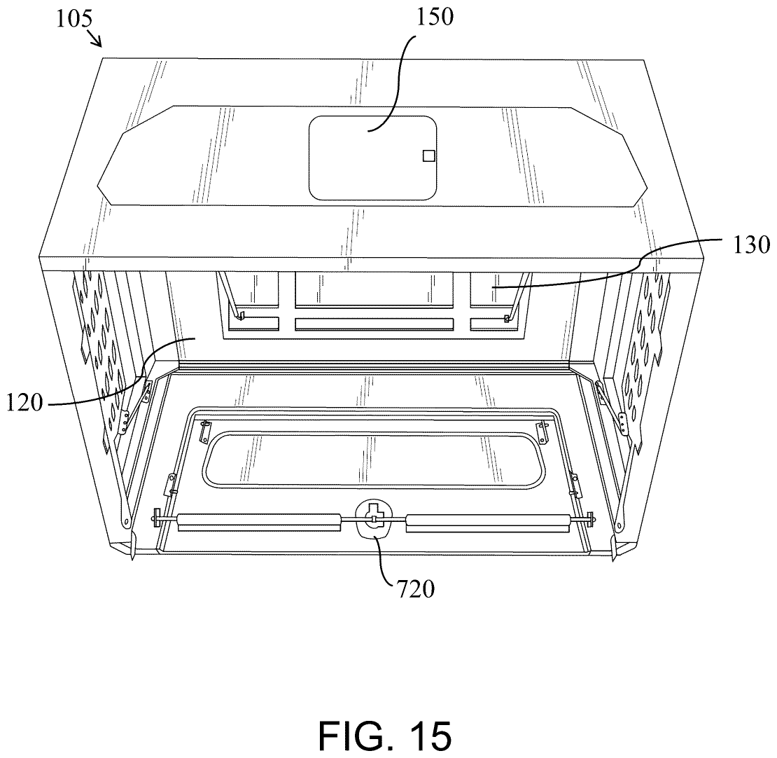

FIG. 15 depicts an example of a bottom view of an interior of the modular camper shell 105 coupled to the rooftop panel 120.

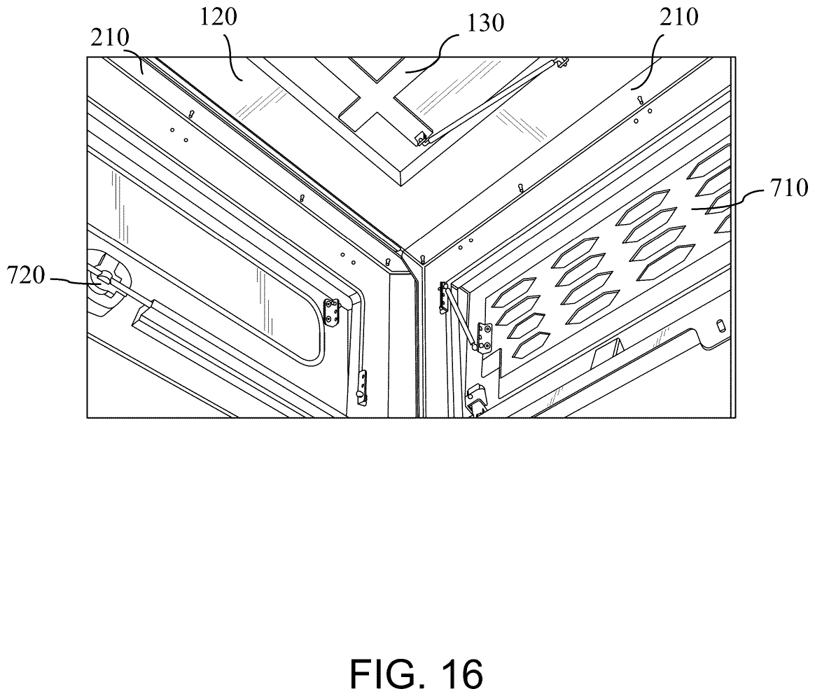

FIG. 16 depicts an example of a bottom view of an interior of the modular camper shell 105 coupled to the rooftop panel 120 using a plurality of bolts inserted into the plurality of apertures.

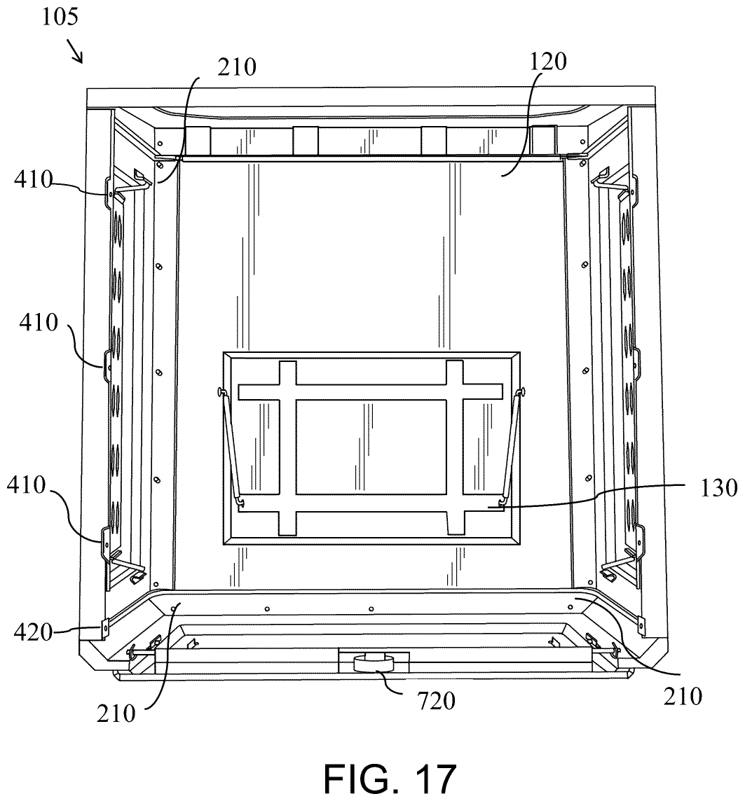

FIG. 17 depicts another example of a bottom view of an interior of the modular camper shell 105 coupled to the rooftop panel 120 using a plurality of bolts inserted into the plurality of apertures. Upward-facing edges 210*******

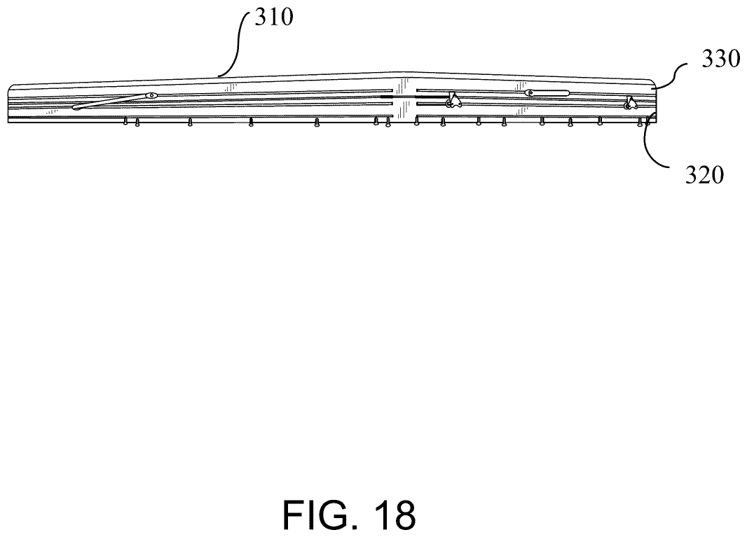

FIG. 18 depicts an example of the rooftop tent 310 in the closed position that is configured to be mounted to the upward-facing edges 210 of the modular camper shell 105 using a plurality of bolts configured to be inserted into the plurality of apertures.

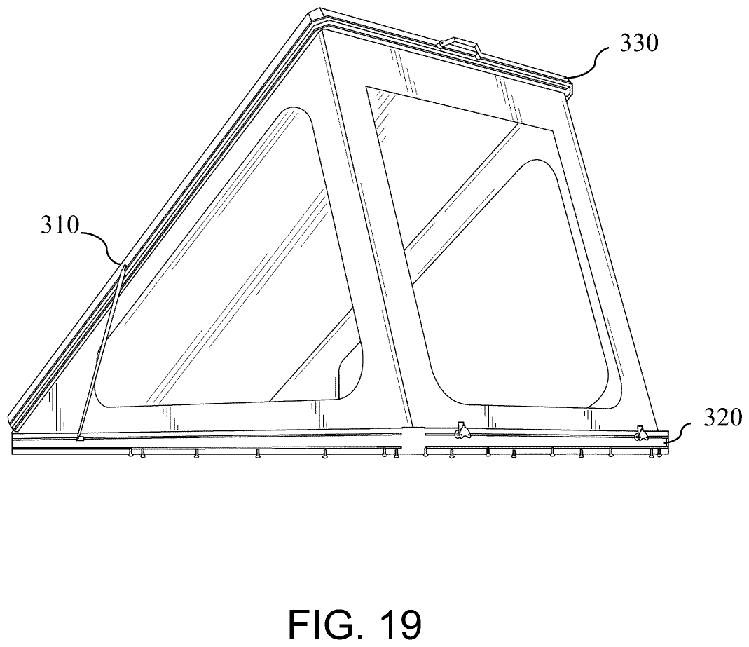

FIG. 19 depicts an example of the rooftop tent 310 in the open position that is configured to be mounted to the upward-facing edges 210 of the modular camper shell 105 using a plurality of bolts configured to be inserted into the plurality of apertures. A gas strut may be used to sustain the rooftop tent 310 in the open position, separating the bottom layer from the top layer.

Terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

While the foregoing is directed to implementations of the present disclosure, other and further implementations of the disclosure may be devised without departing from the basic scope thereof, and the scope thereof is determined by the claims that follow.

What is claimed is:

1. A system comprising:
a modular camper shell configured to selectively couple to a vehicle, the modular camper shell having four walls in which each wall of the four walls is configured to connect at least two walls of the four walls, the at least two walls of the four walls having a first upward-facing edge and a second upward-facing edge extending approximately parallel to each other, the first upward-facing edge and the second upward-facing edge having a plurality of apertures through which a plurality of bolts may be inserted; and
a rooftop panel configured to couple to the at least the first upward-facing edge and the second upward-facing edge using the plurality of bolts, the rooftop panel having a plurality of openings configured to align with the plurality of apertures,
wherein the rooftop panel is configured to be removed from the first upward-facing edge and the second upward-facing edge in response to removing the plurality of bolts at the plurality of openings and the plurality of apertures.

2. The system of claim 1, further comprising:
a rooftop tent configured to couple to the at least the first upward-facing edge and the second upward-facing edge using the plurality of bolts, the rooftop tent having a second plurality of openings configured to align with the plurality of apertures,
wherein the rooftop tent is configured to be removed from the first upward-facing edge and the second upward-facing edge in response to removing the plurality of bolts at the plurality of openings and the plurality of apertures.

3. The system of claim 2, wherein the rooftop tent has a first layer and a second layer that are coupled by a hinge at ends of the first layer and the second layer, the first layer configured to rotate away from the second layer using the hinge to an open position, and wherein the first layer is configured to rotate towards the second layer using the hinge to a closed position.

4. The system of claim 3, wherein the first layer is an upper layer and the second layer is a lower layer and an upper portion may be angled relative to the lower layer in response to the rooftop tent being in the open position.

5. The system of claim 3, wherein at least one of the first layer or the second layer has a slot configured to receive a gas strut for supporting the first layer over the second layer while in the open position.

6. The system of claim 1, wherein the modular camper shell includes side panels configured to open and close using a hinge, and wherein the modular camper shell includes a back panel configured to be locked.

7. The system of claim 6, wherein the side panels are configured to be supported by a gas strut in response to being in an open position.

8. The system of claim 1, wherein the modular camper shell includes a vertical mounting point configured to couple to side railings of the vehicle to prevent vertical movement of the modular camper shell.

9. The system of claim 8, wherein the vertical mounting point extends down from a bottom edge of the modular camper shell in a vertical direction.

10. The system of claim 1, wherein the modular camper shell includes a horizontal mounting point configured to couple to side railings of the vehicle to prevent horizontal movement of the modular camper shell.

11. A system comprising:
a modular camper shell configured to selectively couple to a vehicle, the modular camper shell having four walls in which each wall of the four walls is configured to connect at least two walls of the four walls, the at least two walls of the four walls having a first upward-facing edge and a second upward-facing edge extending approximately parallel to each other, the first upward-facing edge and the second upward-facing edge having a plurality of apertures through which a plurality of bolts may be inserted; and
a rooftop tent configured to couple to the at least the first upward-facing edge and the second upward-facing edge using the plurality of bolts, the rooftop tent having a plurality of openings configured to align with the plurality of apertures,
wherein the rooftop tent is configured to be removed from the first upward-facing edge and the second upward-facing edge in response to removing the plurality of bolts at the plurality of openings and the plurality of apertures.

12. The system of claim 11, wherein the rooftop tent has a first layer and a second layer that are coupled by a hinge at ends of the first layer and the second layer, the first layer configured to rotate away from the second layer using the hinge to an open position, and wherein the first layer is configured to rotate towards the second layer using the hinge to a closed position.

13. The system of claim 12, wherein the first layer is an upper layer and the second layer is a lower layer and an upper portion may be angled relative to the lower layer in response to the rooftop tent being in the open position.

14. The system of claim 12, wherein at least one of the first layer or the second layer has a slot configured to receive a gas strut for supporting the first layer over the second layer while in the open position.

15. The system of claim 11, further comprising:
a rooftop panel configured to couple to the at least the first upward-facing edge and the second upward-facing edge using the plurality of bolts, the rooftop panel having a second plurality of openings configured to align with the plurality of apertures,
wherein the rooftop panel is configured to be removed from the first upward-facing edge and the second upward-facing edge in response to removing the plurality of bolts at the plurality of openings and the plurality of apertures.

16. The system of claim 11, wherein the modular camper shell includes side panels configured to open and close using a hinge, and wherein the modular camper shell includes a back panel configured to be locked.

17. The system of claim 16, wherein the side panels are configured to be supported by a gas strut in response to being in an open position.

18. The system of claim 11, wherein the modular camper shell includes a vertical mounting point configured to couple to side railings of the vehicle to prevent vertical movement of the modular camper shell.

19. The system of claim 18, wherein the vertical mounting point extends down from a bottom edge of the modular camper shell in a vertical direction.

20. The system of claim 11, wherein the modular camper shell includes a horizontal mounting point configured to couple to side railings of the vehicle to prevent horizontal movement of the modular camper shell.
